(19) United States
(12) Patent Application Publication
(10) Pub. No.: US 2016/0224739 A1
(43) Pub. Date: Aug. 4, 2016

(54) System, Method and Software for Predicting Clinical Outcome of a Drug Treatment of Breast Cancer in a Patient

(71) Applicant: PATHWAY PHARMACEUTICALS LTD, Wan Chai (HK)

(72) Inventors: ALEXANDER ZHAVORONKOV, MOSCOW (RU); KSENIA LEZHNINA, PYATIGORSK (RU); MIKHAIL KORZINKIN, MOSCOW (RU); DENIS SHEPELIN, BIYSK (RU); ARTEM ARTEMOV, MOSCOW (RU); ALEXANDER ALIPER, RAMENSKOYE (RU); ANTON BUZDIN, MOSCOW (RU)

(21) Appl. No.: 15/008,471

(22) Filed: Jan. 28, 2016

Related U.S. Application Data
(60) Provisional application No. 62/109,291, filed on Jan. 29, 2015.

(51) Int. Cl. G06F 19/00

(52) U.S. Cl. CPC G06F 19/345

(57) ABSTRACT

The present invention provides systems, methods and software predicting a clinical outcome of a patient having breast cancer, the method including the steps of providing a drug score database (DSD) based on pathway activation strengths (PASs) for a plurality of biological pathways associated with the drug in the treatment of the disorder and comparing the pathway activation strengths of the plurality of biological pathways of the patient with the drug score database to provide a predictive indication if the patient is a responder or non-responder to the drug; and repeating these steps for a plurality of drugs thereby predicting a clinical outcome to the plurality of drugs of the patient to the breast cancer.

### FIELD OF THE INVENTION

The present invention relates generally to systems and methods of analysis of gene signaling pathways, and more specifically to systems and methods for using historic patient databases to predict drug efficacy in a patient with breast cancer.

### BACKGROUND OF THE INVENTION

In the twentieth century, enormous studies were made in combatting infectious diseases, in their detection and drugs to treat them. The major problem in the medical world has thus shifted from treating acute diseases to treating chronic diseases. Over the last few decades, with the advent of genetic engineering, much research and funding has been invested in genomics and gene-based personalized medicine. A need has arisen to develop diagnostic tools for use in the characterization of personalized aspects of chronic diseases.

There are many known molecular pathways in a mammalian body. The molecular pathways include signaling pathways, metabolic pathways and others.

Intracellular signaling pathways (SPs) regulate numerous processes involved in normal and pathological conditions including development, growth, aging and cancer. Many bioinformatic tools have been developed, which analyze SPs.

The information relating to signaling pathway activation (SPA) can be obtained from the massive proteomic or transcriptomic data. Although the proteomic level may be somewhat closer to the biological function of SPA, the transcriptomic level of studies today is far more feasible in terms of performing experimental tests and analyzing the data.

US2008254497A provides a method of determining whether tumor cells or tissue is responsive to treatment with an ErbB pathway-specific drug. In accordance with the invention, measurements are made on such cells or tissues to determine values for total ErbB receptors of one or more types, ErbB receptor dimers of one or more types and their phosphorylation states, and/or one or more ErbB signaling pathway effector proteins and their phosphorylation states. These quantities, or a response index based on them, are positively or negatively correlated with cell or tissue responsiveness to treatment with an ErbB pathway-specific drug. In one aspect, such correlations are determined from a model of the mechanism of action of a ErbB pathway-specific drug on an ErbB pathway. Preferably, methods of the invention are implemented by using sets of binding compounds having releasable molecular tags that are specific for multiple components of one or more complexes formed in ErbB pathway activation. After binding, molecular tags are released and separated from the assay mixture for analysis.

U.S. Pat. No. 8,623,592 discloses methods for treating patients which methods comprise methods for predicting responses of cells, such as tumor cells, to treatment with therapeutic agents. These methods involve measuring, in a sample of the cells, levels of one or more components of a cellular network and then computing a Network Activation State (NAS) or a Network Inhibition State (NIS) for the cells using a computational model of the cellular network. The response of the cells to treatment is then predicted based on the NAS or NIS value that has been computed. The invention also comprises predictive methods for cellular responsiveness in which computation of a NAS or NIS value for the cells (e.g., tumor cells) is combined with use of a statistical classification algorithm Biomarkers for predicting responsiveness to treatment with a therapeutic agent that targets a component within the ErbB signaling pathway are also provided.

Cancer drugs are extremely expensive and should not be given to patients who will not respond thereto. There thus remains a need for systems and methods, which can predict drug efficacy in a patient.

### SUMMARY OF THE INVENTION

It is an object of some aspects of the present invention to provide systems and methods, which use historic patient databases to predict anticancer therapy efficacy in a patient.

It is a further object of some aspects of the present invention to provide systems and methods, which provide statistical predictions to provide an indication if a therapy is likely to be effective in a patient.

Some of the objects of the present invention are to provide novel systems and methods for predicting drug efficacy on breast cancer in a patient.

Some further objects of the present invention are to provide novel systems and methods for predicting drug combination efficacy on breast cancer in a patient.

It is an object of some aspects of the present invention to provide systems and methods, which use historic patient databases to predict drug efficacy on breast cancer in a patient.

It is a further object of some aspects of the present invention to provide systems and methods, which provide statistical predictions to provide an indication if a drug is likely to be effective in a patient, who suffers from breast cancer.

It is another further object of some aspects of the present invention to provide systems and methods, which provide a medical practitioner with a decision on drug treatment economy for a specific patient suffering from breast cancer, which saves the use of the drug in the case where the patient is statistically likely not to respond to the drug.

It is an object of some aspects of the present invention to provide systems and methods, which use historic patient databases to predict drug efficacy in a patient.

It is a further object of some aspects of the present invention to provide systems and methods, which provide statistical predictions to provide an indication if a drug is likely to be effective in a patient, suffering from breast cancer.

It is another further object of some aspects of the present invention to provide systems and methods, which provide a medical practitioner with a decision on drug treatment economy for a specific patient, which saves the use of the drug in the case where the patient is statistically likely not to respond to the drug.

A primary object of the present invention is to provide a prediction of the clinical efficacy of anticancer therapies for treatment of patients with breast cancer using BreastCancerTreatment module of the OncoFinder tool. BreastCancerTreatment uses OncoFinder databases of signaling and metabolic pathways. It provides the probability of being a responder/a non-responder for an individual patient on the basis of a combination of marker signaling and marker metabolic pathways activation/inhibition.

The present invention provides systems, methods and software predicting a clinical outcome of a patient having a disease or disorder, the method including the steps of providing a drug score database (DSD) based on pathway activation strengths (PASs) for a plurality of biological pathways associated with the drug in the treatment of the breast cancer and comparing the pathway activation strengths of the plurality of biological pathways of the patient with the drug score database to provide a predictive indication if the patient is a responder or non-responder to the drug; and repeating these steps for a plurality of drugs thereby predicting a clinical outcome to the plurality of drugs of the patient to the breast cancer.

The biological or molecular pathways include signaling pathways, metabolic pathways and others.

The invention of this patent is to provide a way to estimate possible effectiveness of anticancer treatment for an individual patient. We invented a BreastCancerTreatment module of OncoFinder that provides an opportunity to check in advance if 15 common anticancer therapies may be helpful in treatment of particular patient with breast cancer. This module of OncoFinder systems is able to predict if a patient is a responder or non-responder to 15 anticancer therapies in case of breast cancer. BreastCancerTreatment module has a database of marker signaling and metabolic pathways (marker pathways—pathways that are activated or inhibited significantly different in responders compared to non-responders among patients with breast cancer).

The present invention provides systems, methods and software predicting a clinical outcome of a patient having breast cancer, the method including the steps of providing a drug score database (DSD) based on pathway activation strengths (PASs) for a plurality of biological pathways associated with the drug in the treatment of the breast cancer and comparing the pathway activation strengths of the plurality of biological pathways of the patient with the drug score database to provide a predictive indication if the patient is a responder or non-responder to the drug; and repeating these steps for a plurality of drugs thereby predicting a clinical outcome to the plurality of drugs of the patient to the breast cancer.

The present invention will be more fully understood from the following detailed description of the preferred embodiments thereof, taken together with the drawings.

There is thus provided according to an embodiment of the present invention, a method for predicting a clinical outcome of a patient having breast cancer, the method comprising:
a) providing a drug score database (DSD) based on pathway activation strengths (PASs) for a plurality of biological pathways associated with the drug in the treatment of the breast cancer; and
b) comparing the pathway activation strengths of the plurality of biological pathways of the patient with the drug score database to provide a predictive indication if the patient is a responder or non-responder to the drug;
c) repeating the above steps for a plurality of drugs thereby predicting a clinical outcome to the plurality of drugs of the patient to the breast cancer.

According to an embodiment of the present invention, the providing a drug score database (DSD) step comprises:
i. obtaining proliferative bodily samples and healthy bodily samples from patients;
ii. applying said drug to said patients;
iii. determining responder and non-responder patients to said drug; and
iv. repeating steps i to iii for said plurality of drugs.

According to another embodiment of the present invention, the determining step comprises comparing gene expression in at least one of a signaling pathway and a metabolic pathway.

Furthermore, according to an embodiment of the present invention, the determining step includes comparing gene expression in selected signaling pathways.

Further, according to an embodiment of the present invention, the selected signaling pathways are associated with the drug.

Yet further, according to an embodiment of the present invention, the determining step further includes determining a drug score at least one pathway activation strength (PAS) value for each pathway in the responder and the non-responder patients.

Moreover, according to an embodiment of the present invention, the determining step further includes determining a drug score for the drug based on the at least one pathway activation strength (PAS) value.

Additionally, according to an embodiment of the present invention, the bodily samples are selected from the group consisting of a tissue sample, a cell culture, an individual single cell, a bodily sample, an organism sample and a microorganism sample.

According to an embodiment of the present invention, the biological pathways are signaling pathways.

Further, according to an embodiment of the present invention, the biological pathways are metabolic pathways.

Moreover, according to an embodiment of the present invention, the gene expression includes quantifying expression of plurality of gene products.

Additionally, according to an embodiment of the present invention the gene products includes a set of at least five gene products.

Furthermore, according to an embodiment of the present invention, the method further includes calculating a pathway activation strength (PAS), indicative of the pathway activation of each of the biological pathways.

Additionally, according to an embodiment of the present invention, the calculating step includes adding concentrations of the set of the at least five gene products of the sample and comparing to a same set in the at least one control sample.

Furthermore, according to an embodiment of the present invention, the gene products provide at least one function in the biological pathway.

Further, according to an embodiment of the present invention, the at least one function includes an activation function and a suppressor function.

Yet further, according to an embodiment of the present invention, the at least one function includes an up-regulating function and a down-regulating function.

Additionally, according to an embodiment of the present invention, the determining step includes at least one of profiling gene expression, RNA profiling, RNA sequencing, DNA profiling, DNA sequencing, protein profiling, amino acid sequencing, at least one immunochemical methodology, a mass spectrometry analysis, a microarray technology, a quantitative PCR methodology and combinations thereof.

Additionally, according to an embodiment of the present invention, the method is quantitative.

Additionally or alternatively, the method is qualitative.

Furthermore, according to an embodiment of the present invention the patients are sick.

Additionally, according to an embodiment of the present invention, the sick subject suffers from a proliferative disease or disorder.

Moreover, according to an embodiment of the present invention, the proliferative disease or disorder is cancer.

Additionally, according to an embodiment of the present invention, the proliferative disease or disorder is breast cancer.

Moreover, according to an embodiment of the present invention, the pathway is selected from the group consisting of a Caspase Cascade pathway; a CREB pathway; a GPCR pathway; a CSK3 pathway; an HIF1Alpha Pathway; a VEGF pathway; an ILK pathway; an IP3 pathway; a PPAR pathway; and combinations thereof.

There is thus provided according to another embodiment of the present invention, a computer software product, the product configured for predicting drug efficacy for treating breast cancer in a patient, the product including a computer-readable medium in which program instructions are stored, which instructions, when read by a computer, cause the computer to;
a. provide a drug score database (DSD) based on pathway activation strengths (PASs) for a plurality of biological pathways associated with the drug in the treatment of the breast cancer; and
b. compare said pathway activation strengths of said plurality of biological pathways of said patient with said drug score database to provide a predictive indication if said patient is a responder or non-responder to said drug;
c. repeat steps i) and ii) for a plurality of drugs thereby predicting a clinical outcome to said plurality of drugs of said patient to said breast cancer.

There is thus provided according to an additional embodiment of the present invention, a system for predicting drug efficacy for treating breast cancer in a patient the system including;

a. a processor adapted to activate a computer-readable medium in which program instructions are stored, which instructions, when read by a computer, cause the processor to:
i. provide a drug score database (DSD) based on pathway activation strengths (PASs) for a plurality of biological pathways associated with the drug in the treatment of the breast cancer; and
ii. compare said pathway activation strengths of said plurality of biological pathways of said patient with said drug score database to provide a predictive indication if said patient is a responder or non-responder to said drug;
iii. repeat steps i) and ii) for a plurality of drugs thereby predicting a clinical outcome to said plurality of drugs of said patient to said disorder;

b. a memory for storing said drug score database (DSD); and

c. a display for displaying data associated with said predictive clinical outcome of said patient.

There is thus provided according to another embodiment of the present invention, a computer software product, the product configured for defining a best treatment therapy for a patient having breast cancer, the product including a computer-readable medium in which program instructions are stored, which instructions, when read by a computer, cause the computer to;
i. provide a drug score database (DSD) based on pathway activation strengths (PASs) for a plurality of biological pathways associated with the therapy including at least one drug in the treatment of the breast cancer;
ii. compare the pathway activation strengths of the plurality of biological pathways of the patient with the drug score database to provide a predictive indication if the patient is a responder or non-responder to the drug;
iii. repeat steps i) and ii) for a plurality of drugs thereby predicting a clinical outcome to the plurality of drugs of the patient to the breast cancer; and
iv. output predictive results from step iii to provide a ranking table of best to worst therapies including at least one of the plurality of drugs, predicted for the patient for the cancer.

Additionally, according to another embodiment of the present invention, wherein the therapies are selected from the group appearing in Table 3.

Furthermore, according to another embodiment of the present invention, the predictive indication has an accuracy of at least 0.6.

Additionally, according to another embodiment of the present invention, the predictive indication has an accuracy of at least 0.7.

Moreover, according to another embodiment of the present invention, the predictive indication has an accuracy of at least 0.8.

Furthermore, according to another embodiment of the present invention, A the patient has a response score of more than 0.5.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic illustration of a system for predicting drug efficacy in a patient, in accordance with an embodiment of the present invention;

FIG. 2 is a simplified flowchart of a method for determining activation to mitosis conversion factors (AMCFs), in accordance with an embodiment of the present invention;

FIG. 3 is a simplified flowchart of a method for predicting drug efficacy in a patient, suffering from breast cancer, in accordance with an embodiment of the present invention;

FIG. 4 is a simplified flowchart of a method for predicting drug efficacy in a patient, suffering from breast cancer, in accordance with an embodiment of the present invention;

FIG. 5 is a graph of density of normally distributed x values; and

FIG. 6 is a histogram of responders and non-responders demonstrating the distribution of drug scores within the treatment method, in accordance with an embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

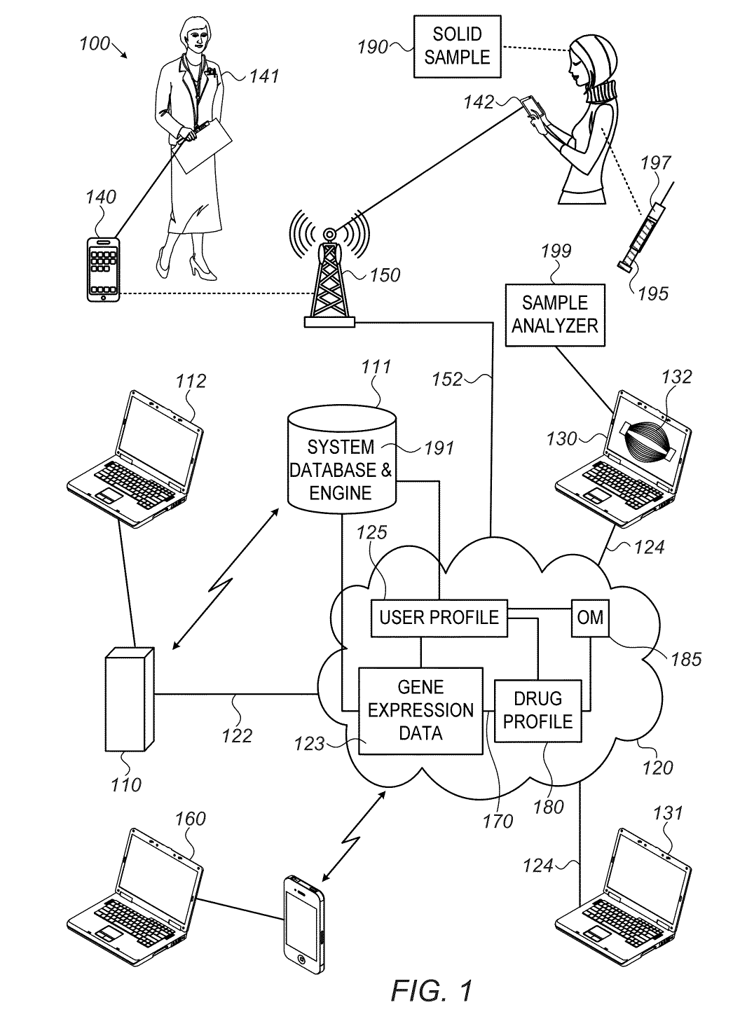

Reference is now made to FIG. 1, which is a simplified schematic illustration of a system for predicting drug efficacy in a patient, suffering from breast cancer, in accordance with an embodiment of the present invention.

System 100 typically includes a server utility 110, which may include one or a plurality of servers and one or more control computer terminals 112l for programming, trouble-shooting servicing and other functions. Server utility 110 includes a system engine 111 and database, 191. Database 191 comprises a user profile database 125, a pathway cloud database 123 and a drug profile database 180. Typically, the database comprises biological pathway databases 170, including gene expression data (179, not shown), metabolic pathway data (178, not shown) and signaling pathway data (178, not shown).

Depending on the capabilities of a mobile device, system 100 may also be incorporated on a mobile device that synchronizes data with a cloud-based platform.

The drug profile database comprises data relating to a large number of drugs for controlling and treating cancer. For each type of drug, the dosage values, pharmo-kinetic data and profile, pharmodynamic data and profiles are included.

The drug profile database further comprises data of drug combinations, including dosage values pharmo-kinetic data and profile, pharmodynamic data and profiles.

A medical professional, research personnel or patient assistant/helper/carer 141 is connected via his/her mobile device 140 to server utility 110. The patient, subject or child 143 is also connected via his/her mobile device 142 to server utility 110. In some cases, the subject may be a mammalian subject, such as a mouse, rat, hamster, monkey, cat or dog, used in research and development. In other cases, the subject may be a vertebrate subject, such as a frog, fish or lizard. The patient or child's is monitored using a sample analyzer 199. Sample analyzer 199, may be associated with one or more computers 130 and with server utility 110. Computer 130 and/or sample analyzer 199 may have software therein for predicting drug efficacy in a patient, as will be described in further details hereinbelow.

Typically, gene expression data 123 (FIG. 1), generated by the software of the present invention, is stored locally and/or in cloud 120 and/or on server 110.

The sample analyzer may be constructed and configured to receive a solid sample 190, such as a biopsy, a hair sample or other solid sample from patient 143, and/or a liquid sample 195, such as, but not limited to, urine, blood or saliva sample. The sample may be extracted by any suitable means, such as by a syringe 197.

The patient, subject or child 143 may be provided with a drug (not shown) by health professional/research/doctor 141.

System 100 further comprises an outputting module 185 for outputting data from the database via tweets, emails, voicemails and computer-generated spoken messages to the user, carers or doctors, via the Internet 120 (constituting a computer network), SMS, Instant Messaging, Fax through link 122.

Users, patients, health care professionals or customers 141, 143 may communicate with server 110 through a plurality of user computers 130, 131, or user devices 140, 142, which may be mainframe computers with terminals that permit individual to access a network, personal computers, portable computers, small hand-held computers and other, that are linked to the Internet 120 through a plurality of links 124. The Internet link of each of computers 130, 131, may be direct through a landline or a wireless line, or may be indirect, for example through an intranet that is linked through an appropriate server to the Internet. System 100 may also operate through communication protocols between computers over the Internet which technique is known to a person versed in the art and will not be elaborated herein.

Users may also communicate with the system through portable communication devices such as mobile phones 140, communicating with the Internet through a corresponding communication system (e.g. cellular system) 150 connectable to the Internet through link 152. As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used.

The system 100 also typically includes at least one call and/or user support and/or tele-health center 160. The service center typically provides both on-line and off-line services to users. The server system 110 is configured according to the invention to carry out the methods of the present invention described herein.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet. Future devices for communications via new communication networks are also deemed to be part of system 100. Memories may be on a physical server and/or in a virtual cloud.

A mobile computing device may also embody a non-synced or offline copy of memories, copies of pathway cloud data, user profiles database, drug profiles database and execute the system, engine locally.

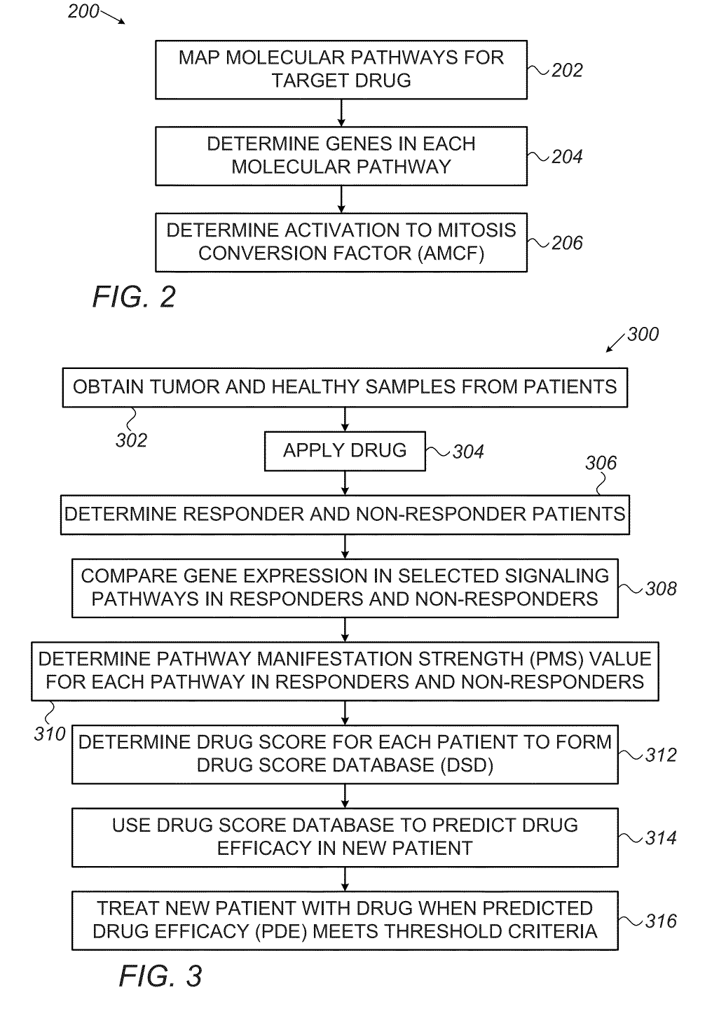

Reference is now made to FIG. 2, which is simplified flowchart of a method for determining activation to mitosis conversion factors (AMCFs), in accordance with an embodiment of the present invention.

There are three basic steps for determining activation to mitosis conversion factors (AMCFs). First, a mapping step 202 is performed to map molecular pathways for a target drug. Thereafter, the genes in each molecular pathway are defined in a gene determining step 204. Thereafter, the activation to mitosis conversion factor (AMCF) is determined in an AMCF determining step 206.

Though this figure refers to signaling pathways, the method is deemed to include any biological pathway, molecular pathway, such as, but not limited to, a metabolic pathway and a signaling pathway.

FIG. 3 is a simplified flowchart 300 of a method for determining predicting drug efficacy in a patient, suffering from breast cancer, in accordance with an embodiment of the present invention.

In a first obtaining step 302, bodily samples are collected from healthy and sick (tumor samples) patients and are stored (such as by refrigeration or freezing).

In an applying drug step 304, a potential drug is applied to the samples in vitro.

In an evaluating step 306, the responder and non-responder samples to the drug are defined.

Thereafter, in a gene expression definition step 308, the gene expression of the responder and non-responder populations are compared.

Thereafter, in a determining pathway manifestation strength (PMS) for each pathway in responders and non-responders is determined in a PMS determining step 310.

In a determining drug score for each patient step 312, the drug scores based on the previous steps are calculated for each patient. The patient drug scores are used to form a drug score database.

Thereafter, the drug score database can be used for each new patient in a prediction step 314 to predict a new patient drug score. A patient will not be treated with the drug if he/she is predicted to be a non responder but will be treated with the drug if he/she is predicted to be a responder.

A primary object of the present invention is to provide a prediction of the clinical efficacy of anticancer therapies for treatment of patients with breast cancer using BreastCancerTreatment module of the OncoFinder tool. BreastCancerTreatment uses OncoFinder databases of signaling and metabolic pathways. It provides the probability of being a responder/a non-responder for an individual patient on the basis of a combination of marker signaling and marker metabolic pathways activation/inhibition.

### OncoFinder

OncoFinder system designed to advise oncologists conducting treatment of patients with malignant tumors. This computer system is a knowledge base that is used to support decisions regarding treatment of individual cancer patients by targeted anticancer drugs—monoclonal antibodies (mabs), kinase inhibitors (nibs), some hormones and stimulants.

OncoFinder knowledgebase operates basic data, which are the results of microarray analysis of the transcriptome cell biopsy as malignant tumors and healthy tissue of similar organs. Result of the system is evaluation of the degree of pathological changes in the pro- and anti-mitotic signaling pathways and the ability of targeted anticancer drugs to compensate for these changes.

This information can be used to forecast the clinical efficacy of drugs for individual patients with cancer and hematologic lesion. The OncoFinder system's knowledgebase based on database of targeted anticancer drugs and pro- and anti-mitotic signaling pathways, which contains information about the interaction of proteins and their corresponding genes. The system is implemented in the form of a cloud online software on “Amazon” web platform at http://aws.amazon.com/.

When calculating the quantitative indicators of pathological changes in pro and anti-mitotic signaling pathways for individual cancer patients, as well as the ability of anticancer drugs to compensate for these changes, OncoFinder system uses 20 the following assumptions. First, graph of protein-protein interactions in each signaling pathway is considered as two parallel chains of events: one leads to activation of signaling pathways, other—to inhibition of this pathway. Second, the expression level of signal transducer protein in each pathway is considered in dormant state much smaller than in activation state (thereby each signal transducer protein in 25 dormant state has deeply unsaturated state).

Thus, the OncoFinder system considers signal transducer protein of each pathway as having equal opportunities cause the activation/inhibition of pathway. Under these assumptions, based on the law of mass action next assessment of pathological changes in the signal pathway (signal outcome, SO) can be proposed,

$$SO = \frac{{{Π}_{i = 1}^{N} [ AGEL ]}_{i}}{{{Π}_{j = 1}^{M} [ RGEL ]}_{j}}$$

In this equation the multiplication is performed over all the genes of activators and inhibitors of the signal present in the pathway, [AGEL]ᵢ (activator gene expression level) and [RGEL]ⱼ (repressor gene expression level) are expression level of activators gene No i and No j, correspondingly.

TThe logarithm for the transition from multiplicative value to additive relative mitogenic significance of cascade (pathway mitogenic strength), which serves to evaluate the degree of pathological changes in the signal pathway:

PAS=AMCF_{p*}ΣₙNIInp*ARRnp*BTIFn*lg(CNRn)

Here CNRn (cancer(case)-to-normal ratio) is the ratio of expression levels of a gene, encoding a protein n, from individual patient to norm (mean value of the control group). Discrete value BTIF (beyond tolerance interval flag) is calculated as:

$$BTIF - \{ \begin{matrix}0 , CNRn lays within the tolerance interval \\ 1 , CNRn lays outside the tolerance interval\end{matrix}$$

Discrete value ARR (activator/repressor role) is defined as follows and stored in the database mitogenetic pathways:

$$ARR = \{ \begin{matrix}- 1 , protein n is the repressor of the pathway p \\ - 0.5 , protein n is rather repressor of the pathway p \\ 0 , protein n is neither repressor nor activator of the pathway p \\ 0.5 , protein n is rather activator of the pathway p \\ 1 , protein n is the activator of the pathway p\end{matrix}$$

Discrete value AMCF (activation-to-mitosis conversion factor):

$$AMCF = \{ \begin{matrix}- 1 , activation prevents mitosis \\ 1 , activation activates mitosis\end{matrix}$$

Discrete value node involvement index:

$$NH = \{ \begin{matrix}0 , there is no protein t in the pathway p \\ 1 , there is protein t in the pathway p\end{matrix}$$

### Medical Database Building

### Data Preparation and Analysis

Datasets expression files were downloaded from GEO database. All datasets were required to have information about clinical response of patients to anticancer therapy such as complete response, partial response, no response, stable disease, progressive disease etc. Samples failed to provide this information were excluded from further analyses. For each dataset a table of gene expression profiles of tumor and normal samples was built by R and Bioconductor (www.bioconductor.org/).

First step is to quantile normalize the gene expression data by R and Bioconductor.

Second step is to put the normalized data to OncoFinder tool and process it with the default OncoFinder parameters: Sigma=2, CNR (cancer/normal ratio of gene expression level) lower limit=0.67, CNR upper limit=1.5. These parameters are used to determine differentially expressed genes in tumor samples compared to normal samples.

OncoFinder algorithm:

1) counts CNRs to all genes and determines differentially expressed genes
2) evaluates the degree of pathological changes in the signaling pathways (PAS)
3) evaluates the degree of pathological changes in the metabolic pathways (PAS)

Third step is to divide all samples of patients into two groups: responders and non-responders according to given information in datasets description.

Final step is to compare PAS values of responders against PAS values of non-responders. R was used to count correlation test and AUC values. Thresholds for p-value of correlation test and AUC values were p-value <=0.05 and AUC >=0.7.

Pathways which passed threshold filters are called marker pathways that significantly differ in responders in comparison to non-responders samples. These marker pathways are used to predict the effectiveness of anticancer therapy for each sample in chosen datasets.

Thus, medical database of marker signaling and metabolic pathways for breast cancer is built for 15 anticancer therapies (Table 1 [appended] and table 2).

### Probability

Probabilities of being a responder and a non-responder are built for an individual patient on the basis of PAS values of each marker pathway.

Assumption: PAS values of signaling and metabolic pathways are normally distributed.

Probability (P) is built as a cumulative density function or distribution function. It returns the area below the given value of “x” or for x=−1, the shaded region in FIG. 5. If the given value of “x”>=mean then probability is built as (1−P). Thus, the range of probability is 0 to 0.5.

### Responsescore

At this stage probabilities of being a responder and a non-responder are built for all patients for all marker pathways separately. To arrive to a decision if a patient is a responder or non-responder the ResponseScore is counted.

$$ResponseScore = \frac{\begin{matrix}Number of marker pathways \cdot \\ \{ P ( responder ) > P ( non \text{-} responder ) \}\end{matrix}}{Number of all marker pathways}$$

P (responder)—probability of being a responder, P (non-responder)—probability of being a non-responder.

If ResponseScore >0.5 a patient is considered to be a responder, otherwise a non-responder.

Response Scores for all samples are in supplementary materials.

PAS values of marker metabolic pathways are shown in Table 2.

TABLE 2
Datasets characteristics. For each dataset anticancer therapy is presented. For all marker
signaling pathways AUC values, PAS threshold and Fisher test p-values are counted when a group
of responders and a group of non-responders to the anticancer therapy are compared.

| GEO | | | | PAS | Fisher |
|---|---|---|---|---|---|
| Series ID | Anticancer therapy | Marker pathways | AUC | threshold | test p-value |
| GSE48905 | fulvestrant | Cellular Anti Apoptosis Pathway | 0.70 | −0.64 | 0.0086 |
| | | (Depolarization) | | | |
| | | Estrogen Main Pathway | 0.72 | −0.66 | 0.0005 |
| | | GPCR Main Pathway | 0.70 | −3.96 | 0.0009 |
| | | Hedgehog Main Pathway | 0.73 | 4.74 | 0.0051 |
| | | HIF1Alpha Pathway (VEGF pathway) | 0.70 | 0.68 | 0.0028 |
| | | DDR Pathway (NER) | 0.71 | 1.60 | 0.0128 |
| | | Cell Cycle Pathway (End of S-phase) | 0.71 | 2.76 | 0.0052 |
| GSE50948 | doxorubicin/paclitaxel | HIF1Alpha Pathway (p53 Hypoxia | 0.70 | −1.06 | 0.0008 |
| | (AT) followed by | pathway) | | | |
| | cyclophosphamide/ | JNK Pathway (Apoptosis Inflammation | 0.73 | 1.20 | 0.0002 |
| | methotrexate/ | Tumorigenesis Cell Migration) | | | |
| | fluorouracil (CMF) | | | | |
| GSE22358 | docetaxel- | AKT Pathway (ERK Pathway) | 0.77 | −0.12 | 0.0052 |
| | capecitabine | AKT Pathway (p53 Degradation) | 0.83 | −0.92 | 0.0014 |
| | | AKT Pathway (Protein Synthesis) | 0.87 | 0.05 | 0.0003 |
| | | Androgen Receptor Pathway | 0.84 | −0.55 | 0.0006 |
| | | (Degradation) | | | |
| | | BRCA1 Main Pathway | 0.78 | 0.86 | 0.0104 |
| | | cAMP Pathway (Degradation of Cell | 0.72 | 1.44 | 0.0195 |
| | | Cycle Regulators) | | | |
| | | Caspase Cascade (Apoptosis) | 0.80 | −0.33 | 0.0055 |
| | | Cellular Anti Apoptosis Pathway | 0.81 | 0.16 | 0.0060 |
| | | (Apoptosis) | | | |
| | | Chemokine Main Pathway | 0.75 | 2.17 | 0.0134 |
| | | EGFR Main Pathway | 0.72 | 0.53 | 0.0325 |
| | | ErbB Family Pathway (Anti-Apoptosis) | 0.76 | −1.00 | 0.0098 |
| | | Fas Signaling Pathway (Negative) | 0.81 | 2.28 | 0.0038 |
| | | Fas Signaling Pathway (Positive) | 0.75 | −1.56 | 0.0308 |
| | | GPCR Pathway (Gene expression) | 0.78 | 1.04 | 0.0096 |
| | | GSK3 Main Pathway | 0.78 | −5.93 | 0.0265 |
| | | GSK3 Pathway (Degradation) | 0.85 | 3.35 | 0.0001 |
| | | HIF1Alpha Pathway (p53 Hypoxia | 0.79 | 0.48 | 0.0067 |
| | | pathway) | | | |
| | | IL-2 Main Pathway | 0.79 | −0.24 | 0.0010 |
| | | IL-2 Pathway (Actin reorganization) | 0.75 | 0.45 | 0.0269 |
| | | IL-2 Pathway (Protein synthesis) | 0.79 | 0.45 | 0.0124 |
| | | JAK-STAT Main Pathway | 0.75 | −2.22 | 0.0055 |
| | | Mitochondrial Apoptosis Main Pathway | 0.78 | 7.51 | 0.0134 |
| | | NGF (Positive) Main Pathway | 0.77 | 0.56 | 0.0094 |
| | | p53 (Negative) Main Pathway | 0.78 | 1.10 | 0.0108 |
| | | Telomere Main Pathway | 0.89 | 0.07 | 0.0001 |
| | | Cell Cycle Pathway (SCC during S- | 0.79 | 2.13 | 0.0094 |
| | | phase) | | | |
| | | SMAD (Negative) Main Pathway | 0.79 | −6.28 | 0.0081 |
| | | SMAD (Positive) Main Pathway | 0.79 | −6.28 | 0.0081 |
| | | TNF (Negative) Main Pathway | 0.80 | 1.96 | 0.0094 |
| | | TNF (Positive) Main Pathway | 0.78 | −0.37 | 0.0108 |
| | | TRAF (Positive) Main Pathway | 0.82 | 2.33 | 0.0044 |
| | | Cell Cycle Pathway (End of S-phase) | 0.84 | −0.67 | 0.0006 |
| | | Ubiquitin Proteasome Main Pathway | 0.85 | −0.09 | 0.0007 |
| GSE23988 | 5-fluorouracil, | AKT Pathway (Protein Synthesis) | 0.71 | −2.09 | 0.0023 |
| | doxorubicin and | ATM Pathway (G2 Mitosis Progression) | 0.77 | −3.03 | 0.0003 |
| | cyclophosphamide | ATM Pathway (G2/M Checkpoint | 0.72 | −1.61 | 0.0025 |
| | followed by | Arrest) | | | |
| | 4 additional | ATM Pathway (S-Phase Progression) | 0.72 | −1.07 | 0.0011 |
| | courses of weekly | Caspase Cascade (Apoptosis) | 0.74 | −7.37 | 0.0010 |
| | docetaxel and | DDR pathway Apoptosis | 0.74 | 3.22 | 0.0010 |
| | capecitabine | G-protein Pathway (Ras family | 0.75 | 3.10 | 0.0000 |
| | | GTPases) | | | |
| | | Mismatch Repair Main Pathway | 0.74 | 8.33 | 0.0001 |
| | | PTEN Main Pathway | 0.72 | −6.26 | 0.0009 |
| | | Cell Cycle Pathway (Origin of S-phase) | 0.77 | 7.06 | 0.0009 |
| | | Cell Cycle Pathway (End of S-phase) | 0.75 | 3.57 | 0.0017 |
| GSE21974 | epirubicine | AKT Pathway (Cell Survival) | 0.81 | −0.33 | 0.0017 |
| | cyclophosphamide | AKT Pathway (Genetic Stability) | 0.76 | −10.02 | 0.0126 |
| | followed by | AKT Pathway (Survival Genes) | 0.71 | 9.80 | 0.0557 |
| | 4 cycles of | ATM Pathway (Cell Survival) | 0.71 | 11.29 | 0.0058 |
| | docetaxel | ATM Pathway (G2 Mitosis Progression) | 0.71 | −5.63 | 0.0063 |
| | | ATM Pathway (S-Phase Progression) | 0.71 | −1.21 | 0.0237 |
| | | cAMP Pathway (Cell Proliferation) | 0.74 | −0.96 | 0.0060 |
| | | Cellular Anti Apoptosis Pathway | 0.85 | 5.12 | 0.0006 |
| | | (Depolarization) | | | |
| | | Chemokine Main Pathway | 0.74 | 87.18 | 0.0014 |
| | | Cytokine Main Pathway | 0.79 | 7.85 | 0.0030 |
| | | G-protein Pathway (Ras family | 0.74 | 8.76 | 0.0128 |
| | | GTPases) | | | |
| | | Glucocorticoid Receptor Main Pathway | 0.76 | 114.32 | 0.0010 |
| | | Glucocorticoid Receptor Pathway | 0.76 | 84.01 | 0.0187 |
| | | (Inflammatory cytokines) | | | |
| | | IL-2 Main Pathway | 0.74 | 71.81 | 0.0237 |
| | | IL-2 Pathway (Actin reorganization) | 0.76 | 9.39 | 0.0051 |
| | | IL-2 Pathway (Protein synthesis) | 0.74 | 5.80 | 0.0049 |
| | | IL-6 Main Pathway | 0.79 | 60.10 | 0.0013 |
| | | MAPK Family Main Pathway | 0.75 | 168.39 | 0.0063 |
| | | PAK Main Pathway | 0.75 | 140.87 | 0.0187 |
| | | PTEN Main Pathway | 0.75 | −16.15 | 0.0128 |
| | | STAT3 Main Pathway | 0.75 | 145.49 | 0.0014 |
| | | TRAF (Negative) Main Pathway | 0.75 | 8.97 | 0.0303 |
| GSE18728 | docetaxel (T) and | AKT Pathway (Cell Cycle Progression) | 0.76 | 4.52 | 0.0877 |
| | capecitabine (X) | AKT Pathway (Genetic Stability) | 0.83 | 1.52 | 0.0181 |
| | | ATM Pathway (G2 Mitosis Progression) | 0.84 | 0.00 | 0.0436 |
| | | ErbB Family Pathway (Anti-Apoptosis) | 0.76 | 1.37 | 0.0206 |
| | | GSK3 Pathway (Degradation) | 0.77 | −2.23 | 0.0573 |
| | | HGF Pathway (Cell cycle progression) | 0.77 | 0.68 | 0.0460 |
| | | Notch Main Pathway | 0.86 | 2.12 | 0.0031 |
| GSE8465 | gemcitabine plus | Cellular Anti Apoptosis Pathway | 0.77 | −1.79 | 0.0181 |
| | doxorubicin + | (Apoptosis) | | | |
| | gemcitabine plus | HGF Main Pathway | 0.75 | −1.01 | 0.0181 |
| | cisplatin | IGF1R Pathway (Glucose uptake) | 0.80 | 0.44 | 0.0063 |
| | | Translation Pathway (Regulation of | 0.76 | 0.49 | 0.0445 |
| | | EIF4F activity) | | | |
| GSE33658 | anastrozole (A), | DDR Pathway (BRCA1-induced | 0.97 | 0.97 | 0.0152 |
| | fulvestrant (F)/ | responses) | | | |
| | and gefitinib | Glucocorticoid Receptor Pathway | 0.87 | 5.97 | 0.0606 |
| | | (Inflammatory cytokines) | | | |
| | | IL-2 Pathway (Apoptosis inhibition) | 0.80 | 1.72 | 0.0606 |
| GSE37946 | trastuzumab | IGF1R Pathway (Glucose uptake) | 0.72 | −0.63 | 0.0054 |
| GSE42822 | fluorouracil/epirubicin/ | AKT Pathway (Protein Synthesis) | 0.72 | −2.16 | 0.0003 |
| | cyclophosphamide | ATM Pathway (G2 Mitosis Progression) | 0.74 | −2.51 | 0.0002 |
| | (FEC) followed by | ATM Pathway (G2/M Checkpoint | 0.71 | −1.80 | 0.0005 |
| | four cycles of | Arrest) | | | |
| | docetaxel/capecitabine | ATM Pathway (S-Phase Progression) | 0.71 | −1.02 | 0.0002 |
| | | DDR pathway Apoptosis | 0.71 | 4.15 | 0.0020 |
| | | HIF1-Alpha Main Pathway | 0.71 | 12.33 | 0.0019 |
| | | Cell Cycle Pathway (Origin of S-phase) | 0.72 | 3.46 | 0.0015 |
| GSE42822 | fluorouracil/epirubicin/ | AHR Pathway (AHR Degradation) | 0.78 | 3.05 | 0.0052 |
| | cyclophosphamide | cAMP Pathway (Axonal Growth) | 0.76 | −1.53 | 0.0154 |
| | (FEC) followed by | cAMP Pathway (Glycolysis) | 0.76 | 1.12 | 0.0048 |
| | four cycles of | CD40 Pathway (Cell Survival) | 0.76 | −0.27 | 0.0112 |
| | docetaxel/capecitabine, | Glucocorticoid Receptor Pathway | 0.73 | 3.50 | 0.0112 |
| | her2+ patients received | (SMAD signaling) | | | |
| | trastuzumab | IL-2 Pathway (Apoptosis inhibition) | 0.74 | −4.90 | 0.0391 |
| | | Interferon Main Pathway | 0.74 | −2.05 | 0.0149 |
| GSE41998 | cyclophosphamide/ | cAMP Pathway (Myocardial | 0.70 | 8.10 | 0.0000 |
| | doxorubicin+ | Contraction) | | | |
| | Ixabepilone | Chemokine Main Pathway | 0.74 | 48.90 | 0.0000 |
| | | Glucocorticoid Receptor Pathway | 0.70 | 24.12 | 0.0000 |
| | | (Inflammatory cytokines) | | | |
| | | IL-2 Main Pathway | 0.71 | 40.09 | 0.0002 |
| | | IL-2 Pathway (Apoptosis inhibition) | 0.70 | 2.60 | 0.0000 |
| | | IL-6 Main Pathway | 0.73 | 40.71 | 0.0000 |
| | | p38 (Negative) Main Pathway | 0.71 | 103.28 | 0.0001 |
| | | p38 (Positive) Main Pathway | 0.71 | 103.28 | 0.0001 |
| | | STAT3 Main Pathway | 0.72 | 46.10 | 0.0000 |
| | | TNF (Negative) Main Pathway | 0.74 | 5.48 | 0.0000 |
| GSE32646 | paclitaxel | DDR Pathway (BRCA1-induced | 0.72 | 2.94 | 0.0003 |
| | followed by 5- | responses) | | | |
| | fluorouracil/epirubicin/ | Chemokine Main Pathway | 0.78 | 30.69 | 0.0000 |
| | cyclophosphamide | Chemokine Pathway (Internalization | 0.71 | 1.79 | 0.0001 |
| | | Degradation Recycling) | | | |
| | | Fas Signaling Pathway (Negative) | 0.71 | 15.74 | 0.0002 |
| | | Glucocorticoid Receptor Main Pathway | 0.74 | 65.39 | 0.0000 |
| | | IL-2 Main Pathway | 0.72 | 42.76 | 0.0009 |
| | | PTEN Main Pathway | 0.70 | −19.79 | 0.0000 |
| | | STAT3 Main Pathway | 0.71 | 38.74 | 0.0008 |
| GSE22513 | paclitaxel/radiation | AKT Main Pathway | 0.71 | 77.60 | 0.0299 |
| | treatment | AKT Pathway (Genetic Stability) | 0.81 | 0.84 | 0.0019 |
| | | Androgen Receptor Pathway (Cell | 0.83 | 3.22 | 0.0030 |
| | | Survival & Cell Growth) | | | |
| | | ATM Pathway (S-Phase Progression) | 0.78 | 0.00 | 0.0019 |
| | | cAMP Pathway (Cell Proliferation) | 0.81 | 1.83 | 0.0095 |
| | | cAMP Pathway (Cytokines Production) | 0.84 | 0.47 | 0.0042 |
| | | Chemokine Main Pathway | 0.86 | 23.11 | 0.0002 |
| | | Circadian Main Pathway | 0.78 | −1.10 | 0.0019 |
| | | Cytokine Main Pathway | 0.79 | 3.98 | 0.0148 |
| | | Erythropoeitin Main Pathway | 0.75 | 18.27 | 0.0292 |
| | | FLT3 Main Pathway | 0.77 | 6.80 | 0.0018 |
| | | G-protein Pathway (Ras family | 0.81 | 5.17 | 0.0084 |
| | | GTPases) | | | |
| | | Glucocorticoid Receptor Main Pathway | 0.84 | 31.25 | 0.0097 |
| | | Glucocorticoid Receptor Pathway | 0.87 | 16.10 | 0.0025 |
| | | (Inflammatory cytokines) | | | |
| | | GPCR Pathway (Gene expression) | 0.77 | 9.07 | 0.0148 |
| | | Growth Hormone Main Pathway | 0.79 | 7.45 | 0.0042 |
| | | Growth Hormone Pathway (Gene | 0.80 | 4.01 | 0.0042 |
| | | expression) | | | |
| | | GSK3 Pathway (Degradation) | 0.77 | −4.92 | 0.0110 |
| | | HIF1-Alpha Main Pathway | 0.80 | 8.44 | 0.0084 |
| | | IL-10 Pathway (Gene expression) | 0.83 | 1.04 | 0.0025 |
| | | IL-10 Pathway (Translational | 0.80 | 0.65 | 0.0006 |
| | | modulation) | | | |
| | | IL-6 Main Pathway | 0.81 | 32.49 | 0.0034 |
| | | JNK Main Pathway | 0.76 | 56.07 | 0.0292 |
| | | MAPK Family Main Pathway | 0.93 | 50.63 | 0.0002 |
| | | DDR pathway (MMR) | 0.74 | 5.75 | 0.0048 |
| | | Mismatch Repair Main Pathway | 0.73 | 14.52 | 0.0034 |
| | | p38 (Negative) Main Pathway | 0.74 | 92.89 | 0.0148 |
| | | p38 (Positive) Main Pathway | 0.74 | 92.89 | 0.0148 |
| | | PAK Main Pathway | 0.80 | 71.17 | 0.0148 |
| | | PPAR Main Pathway | 0.73 | 27.85 | 0.0581 |
| | | STAT3 Main Pathway | 0.88 | 49.96 | 0.0005 |
| | | TGF-beta Main Pathway | 0.76 | 54.16 | 0.0095 |
| | | TRAF (Positive) Main Pathway | 0.86 | 10.89 | 0.0025 |
| | | VEGF Main Pathway | 0.84 | 8.41 | 0.0019 |
| | | Wnt Main Pathway | 0.81 | 37.47 | 0.0097 |
| GSE5462 | letrozole | Androgen Receptor Pathway (Cell | 0.70 | 2.06 | 0.0057 |
| | | Survival & Cell Growth) | | | |
| | | BRCA1 Main Pathway | 0.72 | 1.13 | 0.0045 |

### Prediction System Validation

Cross validation was done to estimate the accuracy of prediction of ResponseScore value for 15 therapies.

The following was done for all samples in analyzed datasets:

Each sample was excluded out of analysis one by one; the rest were analyzed as described in data preparation and analysis section. Thus, all samples were predicted to be a responder or non-responder. Given the datasets information (real clinical outcomes) it is easy to detect the accuracy of the prediction system for particular anticancer therapy (Table 3 and table 4). AUC was also counted between real clinical outcomes and predicted clinical outcomes (Table 3 and table 4).

TABLE 3
Results of BreastCancerTreatment module's ability to predict the
clinical outcome of patients with the use of signaling pathways

| GEO | | | |
|---|---|---|---|
| Series ID | Anticancer therapy | AUC | Accuracy |
| GSE18728 | docetaxel (T) and capecitabine (X) | 0.91 | 0.83 |
| GSE21974 | epirubicine cyclophosphamide | 0.83 | 0.77 |
| | followed by 4 cycles of docetaxel | | |
| GSE22358 | docetaxel-capecitabine | 0.89 | 0.84 |
| GSE22513 | paclitaxel/radiation treatment | 0.90 | 0.81 |
| GSE23988 | 5-fluorouracil, doxorubicin and | 0.79 | 0.72 |
| | cyclophosphamide follwed by | | |
| | 4 additional courses of weekly | | |
| | docetaxel and capecitabine | | |
| GSE32646 | paclitaxel followed by 5- | 0.78 | 0.69 |
| | fluorouracil/epirubicin/cyclo- | | |
| | phosphamide | | |
| GSE33658 | anastrozole (A), fulvestrant | 0.88 | 0.80 |
| | (F)/and gefitinib | | |
| GSE37946 | Trastuzumab | 0.65 | 0.65 |
| GSE41998 | cyclophosphamide/ | 0.75 | 0.70 |
| | doxorubicin + Ixabepilone | | |
| GSE42822 | fluorouracil/epirubicin/cyclo- | 0.73 | 0.69 |
| | phosphamide (FEC) followed | | |
| | by four cycles of docetaxel/ | | |
| | capecitabine | | |
| GSE42822 | fluorouracil/epirubicin/cyclo- | 0.89 | 0.83 |
| | phosphamide (FEC) followed | | |
| | by four cycles of docetaxel/ | | |
| | capecitabine, her2+ patients | | |
| | received trastuzumab | | |
| GSE48905 | Fulvestrant | 0.72 | 0.68 |
| GSE50948 | doxorubicin/paclitaxel (AT) | 0.77 | 0.78 |
| | followed by cyclophosphamide/ | | |
| | methotrexate/fluorouracil (CMF) | | |
| GSE5462 | Letrozole | 0.71 | 0.67 |
| GSE8465 | gemcitabine plus doxorubicin + | 0.86 | 0.83 |
| | gemcitabine plus cisplatin | | |

TABLE 4
Results of BreastCancerTreatment module's ability
to predict the clinical outcome of patients with
the use of signaling and metabolic pathways

| GEO | | | |
|---|---|---|---|
| Series ID | Anticancer therapy | AUC | Accuracy |
| GSE23988 | 5-fluorouracil, doxorubicin and | 0.83 | 0.73 |
| | cyclophosphamide follwed by 4 | | |
| | additional courses of weekly | | |
| | docetaxel and capecitabine | | |
| GSE32646 | paclitaxel followed by 5- | 0.73 | 0.81 |
| | fluorouracil/epirubicin/ | | |
| | cyclophosphamide | | |
| GSE41998 | cyclophosphamide/doxorubicin + | 0.73 | 0.71 |
| | Ixabepilone | | |
| GSE42822 | fluorouracil/epirubicin/ | 0.81 | 0.74 |
| | cyclophosphamide (FEC) followed | | |
| | by four cycles of docetaxel/ | | |
| | capecitabine | | |
| GSE48905 | Fulvestrant | 0.70 | 0.70 |
| GSE5462 | Letrozole | 0.76 | 0.61 |

It is intended to add new, edit and delete unnecessary items in databases. One can edit the contents of a signaling pathways database, genes in signaling pathways, nodes of their graphs, activating and inhibitory connections between them, components of nodes of the signaling pathways graph, as well as anticancer drugs.

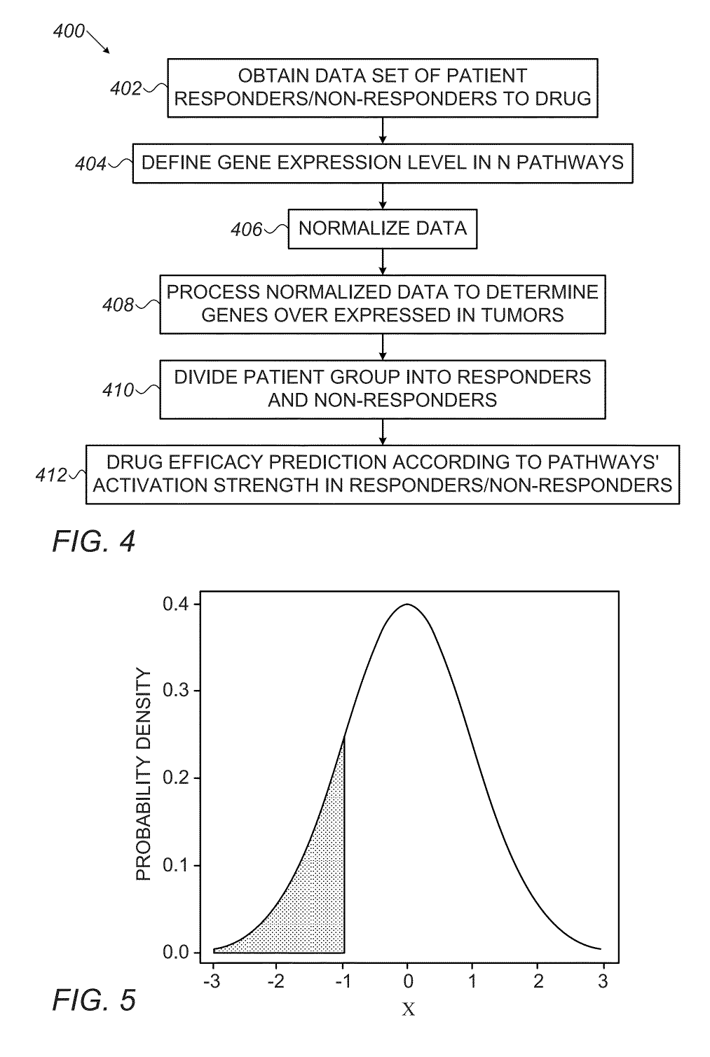

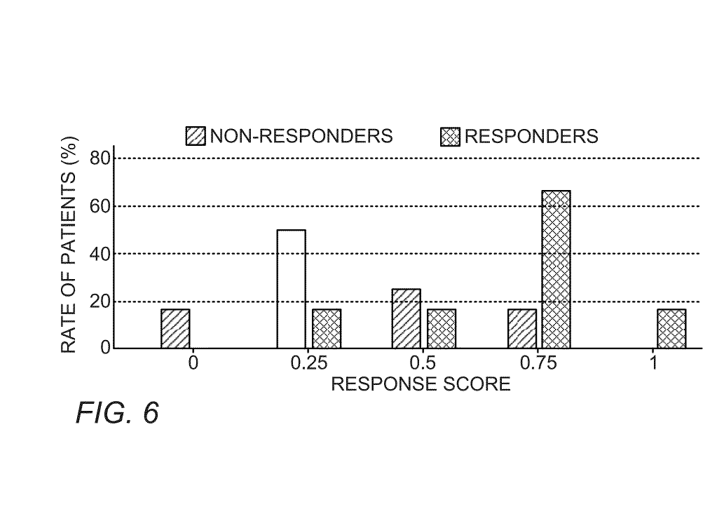

Reference is now made to FIG. 4, which is a simplified flowchart 400 of a method for predicting drug efficacy in a patient, in accordance with an embodiment of the present invention.

In a first data obtaining step 402 data is obtained relating to patient responders/non-responders to one or more drugs. Data preparation and analysis—for example, datasets expression files were downloaded from GEO database. All datasets were required to have information about clinical response of patients to anticancer therapy such as complete response, partial response, no response, stable disease, progressive disease etc. Samples failed to provide this information were excluded from further analyses.

For each dataset, a table of gene expression profiles of tumor and normal samples is built in a gene expression profile definition step 404, using any one or more suitable mathematical tool, such as by R and Bioconductor (www.bioconductor.org/).

In a normalizing data step 406, the gene expression profile data from the profile definition step 404 is normalized.

Thereafter, the normalized gene profile data is inputted into the OncoFinder tool in a data processing step 408. The data is processed using, for example, default OncoFinder parameters: Sigma=2, CNR (cancer/normal ratio of gene expression level) lower limit=0.67, CNR upper limit=1.5. These parameters are used to determine differentially expressed genes in tumor samples compared to normal samples.

OncoFinder algorithm:
counts CNRs to all genes and determines differentially expressed genes
evaluates the degree of pathological changes in the signaling pathways (PAS)
evaluates the degree of pathological changes in the metabolic pathways (PAS)

Thereafter in a patient dividing step 410, all samples of patients are divided into two groups: responders and non-responders according to given information in datasets description.

In a drug efficacy predication step 412, the PAS values of responders to PAS values of non-responders are compared. R is used to count correlation test and AUC values. Thresholds for p-value of correlation test and AUC values were p-value<=0.05 and AUC>=0.7. Pathways which pass threshold filters are called marker pathways that significantly differ in responders in comparison to non-responders samples. These marker pathways are used to predict the effectiveness of each drug (such as an anticancer therapy) for each sample in chosen datasets.

Final step is to compare PAS values of responders against PAS values of non-responders. AUC was used to detect how well the Oncofinder algorithms separate the group being tested into those who are responders and those who are not. R was used to count correlation test and AUC values. Cut-off values for p-value of correlation test and AUC values were p-value<=0.05 and AUC>=0.7. Pathways which passed threshold filters are called marker pathways that significantly differ in responders in comparison to non-responders samples. These marker pathways are used to predict the effectiveness of anticancer therapy for each sample in chosen datasets. PAS threshold of each marker pathway was detected by Fisher test. PAS threshold of a marker pathway shows the cut-off value such as if PAS value is higher than the threshold a patient is likely to be a responder and vice versa when PAS values of responders of a particular marker pathway is higher compared to non-responders' PAS values.

Thus, medical database of marker signaling and metabolic pathways for breast cancer is built for 15 anticancer therapies (Table 1 and table 2).

### Probability

Assumption: PAS values of signaling and metabolic pathways are normally distributed.

Probability (P) is built as a cumulative density function or distribution function. It returns the area below the given value of “x” or for x=-1, the shaded region in FIG. 5. If the given value of “x” >=mean then probability is built as (1−P). Thus, the range of probability is 0 to 0.5.

### ResponseScore

At this stage probabilities of being a responder and a non-responder are built for all patients for all marker pathways separately. To arrive to a decision if a patient is a responder or non-responder the ResponseScore is counted.

$$ResponseScore = \frac{\begin{matrix}Number of marker pathways \cdot \\ \{ P ( responder ) > P ( non \text{-} responder ) \}\end{matrix}}{Number of all marker pathways}$$

P (responder)—probability of being a responder, P (non-responder)—probability of being a non-responder.

If ResponseScore>0.5 a patient is considered to be a responder, otherwise a non-responder.

Response Scores data for provided examples are in supplementary materials.

To improve the prediction power PAS values of marker metabolic pathways were included to analyses (Table 2).

### Prediction System Validation

Cross validation was done to estimate the accuracy of prediction of Response Score value for 15 therapies.

The following was done for all samples in analyzed datasets:

Each sample was excluded out of analysis one by one; the rest were analyzed as described in data preparation and analysis section. Thus, all samples were predicted to be a responder or non-responder. Given the datasets information (real clinical outcomes) it is easy to detect the accuracy of the prediction system for particular anticancer therapy (Table 3 and table 4). AUC was also counted between real clinical outcomes and predicted clinical outcomes (Table 3 and table 4).

### EXAMPLES

The description for methods of prediction of drug efficacy in a responder/non-responder patient shown in FIGS. 3-4 are used to in the examples hereinbelow for various non-limiting examples.

### Structure of Medical Database of Oncofinder

### 1. Nosology

1.1. Breast cancer
1.1.1. Treatment methods
   1.1.1.1. Probability Table
      Table 1. Structure of probability table
      No Probability Table
      col
      1 Sample (data from GEO datasets)
      2 Group (Responder or Non-responder)
      3 Marker Pathway 1 (probability of being a responder or non-responder)
      4 Marker Pathway 2
      . . . Marker Pathway N
   1.1.1.2. PAS1 Table
      Table 2. Structure of PAS1 table
      No PAS1 Table
      col
      1 Marker Pathway
      2 Sample 1
      3 Sample N
   1.1.1.3. Graphic Scheme (Responders-nonresponders histogram)

### The Main Menu of Oncofinder System

OncoFinder system consists of two main parts - the client and the administrative.

For all users personal accounts are created. Profile information is provided by clients.

### The Client Part of the Breastcancertreatment Module

The client part contains menu options <<Biochem Database>>, <<Drugs Database>>, <<Medical Database>>. All clients have their project directories. To work within Medical database project type must be chosen as medical. Within a project one can upload new documents with expression profiles data.

File format requirements:
Accepted file formats are: CSV, TXT, XLS, XLSX with delimeters \t,;
Files must have names in English letters only!
Columns with gene names should be called “SYMBOL”
Columns with Samples must contain “Tumour” in it's name
Columns with Norms mustt contain “Norm” in it's name

One can add useful information about the data in a description field.

All uploaded documents (input) have informational fields:
Document (document name)
Type (input or output)
Information (Number of samples, number of norms, number of genes(Rows))
Date (Create date, Last calculated at, Last calculated by “User_name”)
Description

Processed documents (output) have the same information fields except “Information” field: it contains applied parameters of Oncofinder:
Pathway DataBase (Human, Mouse, Metabolism)
Normal algorithm (Geometric, Arithmetic)
Use sigma: True (Sigma amount)
Use CNR: True (CNR lower, CNR upper)

Treatment methods:

1) Letrozole (2.5mg/day per oral) for three months in the neoadjuvant setting
2) FEC—DtxCap: neoadjuvant four courses of 5-fluorouracil (500 mg/m2), epirubicin (100 mg/m2), and cyclophosphamide (500 mg/m2), given once every 21 days, followed by 12 weeks of docetaxel (35 mg/m2), given once weekly concomitant with capecitabine (850 mg/m2 given twice daily for 14 days, repeated every 21 days)
3) Gem+A—Gem+Cis: 4 cycles of gemcitabine 1200 mg/m2 plus doxorubicin 60 mg/m2 (Gem+Dox), then 4 cycles of gemcitabine 1000 mg/m2 plus cisplatin 70 mg/m2 (Gem+Cis)
4) DtxCap: neoadjuvant docetaxel (75 mg/m2 intravenous) on day 1 and capecitabine (1,000 mg/m2 per oral) twice daily on days 2-15 every 21 days for four cycles
5) EC—Dtx: 4 cycles of neoadjuvant chemotherapy with epirubicine 90 mg/m2 and cyclophosphamide 600mg/m2 every 3 weeks, followed by 4 cycles of docetaxel 100mg/m2
6) DtxCap: neoadjuvant therapy for four 21-day cycles with capecitabine 825 mg/m(2) plus docetaxel 75 mg/m(2)
7) Ptx: three cycles of paclitaxel (175 mg/m2 every 3 wk), followed by twice weekly paclitaxel (30 mg/m2) and concurrent radiation.
8) Ptx—FEC: paclitaxel (80 mg/m2) weekly for 12 cycles followed by 5-fluorouracil (500 mg/m2), epirubicin (75 mg/m2) and cyclophosphamide (500 mg/m2) every 3 weeks for four cycles
9) AFG: neoadjuvant anastrozole 1 mg per oral daily, and fulvestrant 250 mg intramuscular monthly (AF group), or anastrozole 1 mg per oral daily, and fulvestrant 250 mg intramuscular monthly and gefitinib 250 mg per oral daily (AFG group). All patients then received the three drugs (AFG) to complete a total of 4 months from the time of enrollment.
10) Neoadjuvant FE+trastuzumab or AC-T+trastuzumab (fluorouracil/epirubicin or Adriamycin/cyclophosphamide-taxol) plus trastuzumab
11) AC—Ixabepilone: neoadjuvant therapy with 4 cycles of AC (doxorubicin 60 mg/m2 intravenously and cyclophosphamide 600 mg/m2 intravenously) given every 3 weeks, followed by 4 cycles of ixabepilone (40 mg/m2 3-hour infusion) given every 3 weeks
12) FEC—DtxCap: four cycles of 5-fluorouracil/epirubicin/cyclophosphamide followed by four cycles of docetaxel/capecitabine
13) FEC—DtxCap+trastuzumab: four cycles of 5-fluorouracil/epirubicin/cyclophosphamide followed by four cycles of docetaxel/capecitabine+trastuzumab
14) Fulvestrant 500 mg or 250 mg in the neoadjuvant setting
15) AT—CMF: neoadjuvant doxorubicin (60 mg/m2) and paclitaxel (150 mg/m2, every 3 weeks) ×3, followed by cyclophosphamide (600 mg/m2, every 4 weeks), methotrexate (40 mg/m2, every 4 weeks), and fluorouracil (600 mg/m2, every 4 weeks) on days 1 and 8 x3.

Output
Information (description of the dataset)
   1) Name
   2) Number of patients
   3) Histological type
   4) Grade
   5) Hormone receptor status
   6) HER2 status
   7) Stage
   8) Treatment
   9) Citation(s)
   10) Organization name
Probability table
   1) Sample
   2) Group (Responder or Non-responder)
   3) Marker Pathways
PAS 1 Table (PAS values)
Histogram (FIG. 2)

### The Administrative Part of the Breastcancertreatment Module

It is intended to add new, edit and delete unnecessary items in databases. You can edit the contents of a signaling pathways database, genes in signaling pathways, nodes of their graphs, activating and inhibitory connections between them, components of nodes of the signaling pathways graph, as well as anticancer drugs.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

TABLE 1
Datasets characteristics. For each dataset anticancer therapy is presented. For all
marker signaling pathways mean PAS values and sd of PAS values are counted for a group of
responders and a group of non-responders to the anticancer therapy

| GEO | | | | | Non- | Non- |
|---|---|---|---|---|---|---|
| Series | Anticancer | | Responders | Responders | responders | responders |
| ID | therapy | Marker pathways | mean | sd | mean | sd |
| GSE48905 | fulvestrant | Cellular Anti Apoptosis Pathway (Depolarization) | −0.64 | 0.58 | −0.23 | 0.48 |
| | | Estrogen Main Pathway | 3.47 | 9.72 | 8.91 | 5.90 |
| | | GPCR Main Pathway | 1.56 | 13.06 | 10.04 | 7.36 |
| | | Hedgehog Main Pathway | 4.17 | 1.15 | 3.24 | 1.06 |
| | | HIF1Alpha Pathway (VEGF pathway) | 0.45 | 1.29 | 1.25 | 0.92 |
| | | DDR Pathway (NER) | 4.59 | 1.72 | 3.18 | 2.40 |
| | | Cell Cycle Pathway (End of S-phase) | 3.24 | 1.88 | 1.80 | 1.86 |
| GSE50948 | doxorubicin/ | HIF1Alpha Pathway (p53 Hypoxia pathway) | −0.89 | 0.68 | −0.30 | 1.30 |
| | paclitaxel | JNK Pathway (Apoptosis Inflammation | 0.83 | 1.58 | 1.77 | 1.42 |
| | (AT) | Tumorigenesis Cell Migration) | | | | |
| | followed by | | | | | |
| | cyclophosphamide/ | | | | | |
| | methotrexate/ | | | | | |
| | fluorouracil | | | | | |
| | (CMF) | | | | | |
| GSE22358 | docetaxel- | AKT Pathway (ERK Pathway) | 0.35 | 1.60 | −1.05 | 0.95 |
| | capecitabine | AKT Pathway (p53 Degradation) | 1.22 | 1.26 | −0.34 | 1.21 |
| | | AKT Pathway (Protein Synthesis) | −0.32 | 0.57 | 0.24 | 0.34 |
| | | Androgen Receptor Pathway (Degradation) | −5.86 | 5.09 | −0.49 | 2.16 |
| | | BRCA1 Main Pathway | 8.20 | 5.78 | 2.94 | 3.68 |
| | | cAMP Pathway (Degradation of Cell Cycle | −0.10 | 1.22 | 0.96 | 1.55 |
| | | Regulators) | | | | |
| | | Caspase Cascade (Apoptosis) | −1.98 | 2.25 | 0.08 | 1.21 |
| | | Cellular Anti Apoptosis Pathway (Apoptosis) | 0.52 | 2.32 | −2.13 | 2.49 |
| | | Chemokine Main Pathway | 8.25 | 10.64 | −0.56 | 3.77 |
| | | EGFR Main Pathway | −0.22 | 4.95 | −4.83 | 6.27 |
| | | ErbB Family Pathway (Anti-Apoptosis) | 0.20 | 0.58 | −0.51 | 0.87 |
| | | Fas Signaling Pathway (Negative) | 3.75 | 3.62 | 0.15 | 1.75 |
| | | Fas Signaling Pathway (Positive) | 1.53 | 1.74 | −0.09 | 1.81 |
| | | GPCR Pathway (Gene expression) | 3.24 | 3.63 | 0.19 | 1.56 |
| | | GSK3 Main Pathway | −10.51 | 14.68 | 2.35 | 6.51 |
| | | GSK3 Pathway (Degradation) | −2.04 | 5.01 | 3.98 | 3.62 |
| | | HIF1Alpha Pathway (p53 Hypoxia pathway) | 1.60 | 1.59 | 0.10 | 0.79 |
| | | IL-2 Main Pathway | 5.20 | 9.64 | −2.75 | 2.11 |
| | | IL-2 Pathway (Actin reorganization) | 0.51 | 1.92 | −1.20 | 1.90 |
| | | IL-2 Pathway (Protein synthesis) | 0.61 | 1.10 | −0.73 | 1.37 |
| | | JAK-STAT Main Pathway | −0.70 | 2.63 | −3.82 | 3.77 |
| | | Mitochondrial Apoptosis Main Pathway | 13.60 | 9.63 | 4.80 | 6.11 |
| | | NGF (Positive) Main Pathway | 0.99 | 2.73 | −1.99 | 2.77 |
| | | p53 (Negative) Main Pathway | 1.36 | 2.94 | −1.52 | 2.29 |
| | | Telomere Main Pathway | 1.22 | 1.55 | −1.21 | 1.64 |
| | | Cell Cycle Pathway (SCC during S-phase) | 2.70 | 2.15 | 0.63 | 1.20 |
| | | SMAD (Negative) Main Pathway | −8.57 | 6.99 | −1.15 | 5.17 |
| | | SMAD (Positive) Main Pathway | −8.57 | 6.99 | −1.15 | 5.17 |
| | | TNF (Negative) Main Pathway | 2.33 | 1.91 | 0.41 | 1.31 |
| | | TNF (Positive) Main Pathway | 0.68 | 4.30 | −2.90 | 1.75 |
| | | TRAF (Positive) Main Pathway | 4.11 | 5.18 | −0.53 | 2.05 |
| | | Cell Cycle Pathway (End of S-phase) | 0.99 | 1.60 | −0.94 | 1.25 |
| | | Ubiquitin Proteasome Main Pathway | 4.63 | 9.53 | −4.48 | 2.93 |
| GSE23988 | 5- | AKT Pathway (Protein Synthesis) | −2.51 | 1.03 | −1.84 | 0.85 |
| | fluorouracil, | ATM Pathway (G2 Mitosis Progression) | −3.66 | 1.04 | −2.52 | 1.36 |
| | doxorubicin | ATM Pathway (G2/M Checkpoint Arrest) | −5.19 | 1.68 | −3.30 | 2.76 |
| | and | ATM Pathway (S-Phase Progression) | −2.07 | 0.86 | −1.33 | 1.01 |
| | cyclophosphamide | Caspase Cascade (Apoptosis) | −8.87 | 2.70 | −6.48 | 3.30 |
| | followed by | DDR pathway Apoptosis | 4.76 | 3.03 | 2.55 | 2.71 |
| | 4 additional | G-protein Pathway (Ras family GTPases) | 4.78 | 1.59 | 3.28 | 2.03 |
| | courses of | Mismatch Repair Main Pathway | 10.18 | 5.20 | 5.91 | 4.22 |
| | weekly | PTEN Main Pathway | −8.99 | 4.19 | −5.81 | 4.13 |
| | docetaxel | Cell Cycle Pathway (Origin of S-phase) | 11.12 | 7.26 | 4.64 | 5.51 |
| | and | Cell Cycle Pathway (End of S-phase) | 4.72 | 3.02 | 2.10 | 2.66 |
| | capecitabine | | | | | |
| GSE21974 | epirubicine | AKT Pathway (Cell Survival) | −2.24 | 1.23 | −0.33 | 1.64 |
| | cyclophosphamide | AKT Pathway (Genetic Stability) | −10.03 | 2.36 | −8.16 | 2.28 |
| | followed by | AKT Pathway (Survival Genes) | 8.73 | 2.52 | 10.70 | 2.22 |
| | 4 cycles of | ATM Pathway (Cell Survival) | 12.18 | 1.96 | 13.64 | 1.62 |
| | docetaxel | ATM Pathway (G2 Mitosis Progression) | −5.32 | 1.39 | −4.23 | 1.15 |
| | | ATM Pathway (S-Phase Progression) | −2.03 | 1.17 | −1.09 | 1.02 |
| | | cAMP Pathway (Cell Proliferation) | −0.11 | 0.56 | −0.83 | 0.88 |
| | | Cellular Anti Apoptosis Pathway (Depolarization) | 5.74 | 0.85 | 4.62 | 1.08 |
| | | Chemokine Main Pathway | 81.89 | 12.16 | 71.49 | 9.00 |
| | | Cytokine Main Pathway | 9.46 | 5.83 | 5.43 | 4.08 |
| | | G-protein Pathway (Ras family GTPases) | 9.28 | 1.73 | 7.73 | 1.59 |
| | | Glucocorticoid Receptor Main Pathway | 114.78 | 14.66 | 101.57 | 9.80 |
| | | Glucocorticoid Receptor Pathway (Inflammatory | 77.54 | 12.50 | 65.46 | 11.04 |
| | | cytokines) | | | | |
| | | IL-2 Main Pathway | 87.87 | 17.16 | 73.52 | 15.54 |
| | | IL-2 Pathway (Actin reorganization) | 9.77 | 2.46 | 7.54 | 2.31 |
| | | IL-2 Pathway (Protein synthesis) | 5.29 | 2.54 | 3.55 | 1.92 |
| | | IL-6 Main Pathway | 56.54 | 16.34 | 41.13 | 10.78 |
| | | Mab targets | 34.59 | 6.70 | 29.78 | 5.69 |
| | | MAPK Family Main Pathway | 162.06 | 15.18 | 147.58 | 14.04 |
| | | PAK Main Pathway | 133.08 | 15.18 | 119.09 | 15.10 |
| | | PTEN Main Pathway | −17.15 | 2.95 | −14.33 | 3.37 |
| | | STAT3 Main Pathway | 142.05 | 25.27 | 120.57 | 18.83 |
| | | TRAF (Negative) Main Pathway | 7.02 | 1.44 | 8.38 | 1.41 |
| GSE18728 | docetaxel | AKT Pathway (Cell Cycle Progression) | 3.17 | 1.39 | 1.88 | 1.06 |
| | (T) and | AKT Pathway (Genetic Stability) | 3.17 | 1.39 | 1.11 | 1.89 |
| | capecitabine | ATM Pathway (G2 Mitosis Progression) | 0.77 | 0.89 | −0.79 | 1.21 |
| | (X) | ErbB Family Pathway (Anti-Apoptosis) | 0.88 | 0.75 | 0.22 | 0.54 |
| | | GSK3 Pathway (Degradation) | −4.67 | 3.43 | −1.21 | 3.18 |
| | | HGF Pathway (Cell cycle progression) | 0.42 | 0.48 | 1.33 | 0.98 |
| | | Notch Main Pathway | 1.27 | 0.76 | 3.01 | 1.90 |
| GSE8465 | gemcitabine | Cellular Anti Apoptosis Pathway (Apoptosis) | −1.29 | 1.77 | 0.18 | 1.04 |
| | plus | HGF Main Pathway | 2.18 | 2.66 | −0.31 | 2.33 |
| | doxorubicin + | IGF1R Pathway (Glucose uptake) | 0.53 | 0.39 | 0.10 | 0.33 |
| | gemcitabine | Translation Pathway (Regulation of EIF4F | 2.86 | 2.01 | 0.67 | 2.19 |
| | plus | activity) | | | | |
| | cisplatin | | | | | |
| GSE33658 | anastrozole | DDR Pathway (BRCA1-induced responses) | 3.70 | 1.61 | 0.51 | 1.56 |
| | (A), | Glucocorticoid Receptor Pathway (Inflammatory | 7.76 | 3.67 | 3.14 | 2.45 |
| | fulvestrant | cytokines) | | | | |
| | (F)/and | IL-2 Pathway (Apoptosis inhibition) | 2.08 | 1.31 | 0.60 | 0.38 |
| | gefitinib | | | | | |
| GSE37946 | trastuzumab | IGF1R Pathway (Glucose uptake) | −0.82 | 0.98 | −0.01 | 1.18 |
| GSE42822 | fluorouracil/ | AKT Pathway (Protein Synthesis) | −2.44 | 0.99 | −1.77 | 0.78 |
| | epirubicin/cyclophosphamide | ATM Pathway (G2 Mitosis Progression) | −3.53 | 0.93 | −2.58 | 1.28 |
| | (FEC) | ATM Pathway (G2/M Checkpoint Arrest) | −5.09 | 1.75 | −3.36 | 2.75 |
| | followed by | ATM Pathway (S-Phase Progression) | −1.93 | 0.80 | −1.27 | 0.98 |
| | four cycles | DDR pathway Apoptosis | 4.66 | 2.73 | 2.97 | 2.49 |
| | of | HIF1-Alpha Main Pathway | 13.16 | 4.82 | 9.96 | 3.07 |
| | docetaxel/capecitabine | Cell Cycle Pathway (Origin of S-phase) | 9.65 | 6.81 | 4.91 | 4.82 |
| GSE42822 | fluorouracil/ | AHR Pathway (AHR Degradation) | 1.37 | 1.08 | 2.83 | 2.03 |
| | epirubicin/cyclophosphamide | cAMP Pathway (Axonal Growth) | −1.87 | 0.58 | −1.14 | 0.87 |
| | (FEC) | cAMP Pathway (Glycolysis) | 0.55 | 0.78 | 1.83 | 1.45 |
| | followed by | CD40 Pathway (Cell Survival) | −1.28 | 1.58 | 0.13 | 0.94 |
| | four cycles | Glucocorticoid Receptor Pathway (SMAD | 2.25 | 1.12 | 3.37 | 1.32 |
| | of | signaling) | | | | |
| | docetaxel/capecitabine, her2+ | IL-2 Pathway (Apoptosis inhibition) | −3.99 | 1.85 | −2.57 | 1.35 |
| | patients | Interferon Main Pathway | −0.30 | 3.56 | 2.76 | 3.76 |
| | received | | | | | |
| | trastuzumab | | | | | |
| GSE41998 | cyclophosphamide/ | cAMP Pathway (Myocardial Contraction) | 6.29 | 2.09 | 8.69 | 3.75 |
| | doxorubicin + | Chemokine Main Pathway | 60.95 | 11.54 | 50.15 | 13.44 |
| | Ixabepilone | Glucocorticoid Receptor Pathway (Inflammatory | 32.67 | 13.30 | 24.20 | 12.54 |
| | | cytokines) | | | | |
| | | IL-2 Main Pathway | 42.77 | 10.59 | 35.00 | 11.08 |
| | | IL-2 Pathway (Apoptosis inhibition) | 4.92 | 1.43 | 3.80 | 1.69 |
| | | IL-6 Main Pathway | 48.48 | 12.20 | 37.79 | 13.98 |
| | | p38 (Negative) Main Pathway | 121.70 | 25.91 | 102.32 | 26.01 |
| | | p38 (Positive) Main Pathway | 121.70 | 25.91 | 102.32 | 26.01 |
| | | STAT3 Main Pathway | 67.55 | 21.75 | 50.92 | 21.28 |
| | | TNF (Negative) Main Pathway | 6.84 | 2.45 | 4.70 | 2.52 |
| GSE32646 | paclitaxel | DDR Pathway (BRCA1-induced responses) | 5.80 | 2.93 | 3.16 | 3.44 |
| | followed by | Chemokine Main Pathway | 38.47 | 8.38 | 30.20 | 8.40 |
| | 5- | Chemokine Pathway (Internalization Degradation | 3.40 | 1.72 | 2.39 | 1.45 |
| | fluorouracil/ | Recycling) | | | | |
| | epirubicin/cyclophosphamide | Fas Signaling Pathway (Negative) | 17.43 | 2.49 | 15.47 | 3.61 |
| | | Glucocorticoid Receptor Main Pathway | 64.05 | 13.08 | 53.80 | 10.07 |
| | | IL-2 Main Pathway | 45.43 | 12.67 | 36.78 | 9.30 |
| | | Mab targets | 12.50 | 5.88 | 8.06 | 4.37 |
| | | PTEN Main Pathway | −21.18 | 3.39 | −18.82 | 3.97 |
| | | STAT3 Main Pathway | 52.75 | 20.87 | 39.58 | 14.97 |
| GSE22513 | paclitaxel/radiation | AKT Main Pathway | 80.27 | 15.77 | 67.73 | 13.89 |
| | treatment | AKT Pathway (Genetic Stability) | −0.26 | 1.10 | 1.42 | 1.70 |
| | | Androgen Receptor Pathway (Cell Survival & Cell | 3.71 | 1.16 | 2.26 | 0.86 |
| | | Growth) | | | | |
| | | ATM Pathway (S-Phase Progression) | −1.26 | 0.66 | −0.30 | 1.24 |
| | | cAMP Pathway (Cell Proliferation) | 1.73 | 0.50 | 1.17 | 0.65 |
| | | cAMP Pathway (Cytokines Production) | 1.38 | 1.44 | 0.20 | 0.40 |
| | | Chemokine Main Pathway | 28.12 | 3.54 | 19.75 | 7.02 |
| | | Circadian Main Pathway | −0.76 | 0.45 | −1.69 | 1.23 |
| | | Cytokine Main Pathway | 4.04 | 2.88 | 1.64 | 1.53 |
| | | Erythropoeitin Main Pathway | 24.01 | 5.66 | 18.77 | 3.81 |
| | | FLT3 Main Pathway | 6.78 | 2.83 | 4.40 | 2.06 |
| | | G-protein Pathway (Ras family GTPases) | 7.17 | 2.06 | 4.67 | 2.16 |
| | | Glucocorticoid Receptor Main Pathway | 38.88 | 5.58 | 27.86 | 8.70 |
| | | Glucocorticoid Receptor Pathway (Inflammatory | 23.25 | 6.39 | 12.89 | 5.41 |
| | | cytokines) | | | | |
| | | GPCR Pathway (Gene expression) | 8.87 | 3.66 | 5.61 | 2.70 |
| | | Growth Hormone Main Pathway | 8.40 | 1.31 | 6.78 | 1.86 |
| | | Growth Hormone Pathway (Gene expression) | 5.09 | 1.44 | 2.54 | 2.58 |
| | | GSK3 Pathway (Degradation) | −4.90 | 2.96 | −1.31 | 3.95 |
| | | HIF1-Alpha Main Pathway | 12.76 | 3.06 | 8.05 | 4.75 |
| | | IL-10 Pathway (Gene expression) | 2.70 | 1.26 | 0.94 | 1.71 |
| | | IL-10 Pathway (Translational modulation) | 1.03 | 1.52 | −0.47 | 0.72 |
| | | IL-6 Main Pathway | 27.32 | 12.87 | 13.19 | 8.06 |
| | | JNK Main Pathway | 65.31 | 8.49 | 54.42 | 10.67 |
| | | Mab targets | 4.90 | 1.26 | 2.82 | 2.31 |
| | | MAPK Family Main Pathway | 57.60 | 6.25 | 42.53 | 8.99 |
| | | DDR pathway (MMR) | 6.10 | 2.42 | 4.15 | 1.87 |
| | | Mismatch Repair Main Pathway | 11.42 | 4.81 | 8.05 | 3.31 |
| | | p38 (Negative) Main Pathway | 90.94 | 17.32 | 75.11 | 13.82 |
| | | p38 (Positive) Main Pathway | 90.94 | 17.32 | 75.11 | 13.82 |
| | | PAK Main Pathway | 70.69 | 7.88 | 59.42 | 10.50 |
| | | PPAR Main Pathway | 26.42 | 3.92 | 20.75 | 6.74 |
| | | STAT3 Main Pathway | 54.01 | 9.24 | 37.36 | 10.65 |
| | | TGF-beta Main Pathway | 54.63 | 7.92 | 45.05 | 10.23 |
| | | TRAF (Positive) Main Pathway | 14.07 | 2.61 | 9.72 | 2.77 |
| | | VEGF Main Pathway | 10.49 | 2.01 | 6.36 | 3.19 |
| | | Wnt Main Pathway | 44.12 | 5.11 | 34.66 | 9.31 |
| GSE5462 | letrozole | Androgen Receptor Pathway (Cell Survival & | 1.74 | 2.50 | 3.36 | 2.53 |
| | | Cell Growth) | | | | |
| | | BRCA1 Main Pathway | 2.04 | 3.83 | 5.02 | 4.18 |

1. A method for predicting a clinical outcome of a patient having a breast cancer, the method comprising:
i. providing a drug score database (DSD) based on pathway activation strengths (PASs) for a plurality of biological pathways associated with the drug in the treatment of the breast cancer; and
ii. comparing said pathway activation strengths of said plurality of biological pathways of said patient with said drug score database to provide a predictive indication if said patient is a responder or non-responder to said drug;
iii. repeating steps a) and b) for a plurality of drugs thereby predicting a clinical outcome to said plurality of drugs of said patient to said breast cancer.

2. A method according to claim 1, wherein said providing a drug score database (DSD) step comprises:
i. obtaining proliferative bodily samples and healthy bodily samples from patients;
ii. applying said drug to said patients;
iii. determining responder and non-responder patients to said drug; and
iv. repeating steps i to iii for said plurality of drugs.

3. A method according to claim 2, wherein said determining step comprises comparing gene expression in at least one of a signaling pathway and a 2 5 metabolic pathway.

4. A method according to claim 3, wherein said at least one of a signaling pathway and said metabolic pathway is associated with said drug.

5. A method according to claim 2, wherein said determining step further comprises determining a drug score at least one pathway activation strength (PAS) value for each pathway in said responder and said non-responder patients.

6. A method according to claim 5, wherein said determining step further comprises determining a drug score for said drug based on said at least one pathway activation strength (PAS) value.

7. A method according to claim 2, wherein said bodily samples are selected from the group consisting of a tissue sample, a cell culture, an individual single cell, a bodily sample, an organism sample and a microorganism sample.

8. A method according to claim 1, wherein said biological pathways are signaling pathways.

9. A method according to claim 1, wherein said biological pathways are metabolic pathways.

10. A method according to claim 3, wherein said gene expression comprises quantifying expression of plurality of gene products.

11. A method according to claim 10, wherein said gene products comprises a set of at least five gene products.

12. A method according to claim 12, wherein said calculating step comprises adding concentrations of said set of said at least five gene products of said sample and comparing to a same set in said at least one control sample.

13. A method according to claim 13, wherein said gene products provide at least one function in said biological pathway.

14. A method according to claim 13, wherein said at least one function comprises an activation function and a suppressor function.

15. A method according to claim 14, wherein said at least one function comprises an up-regulating function and a down-regulating function.

16. A method according to claim 2, wherein said determining step comprises at least one of profiling gene expression, RNA profiling, RNA sequencing, DNA profiling, DNA sequencing, protein profiling, amino acid sequencing, at least one immunochemical methodology, a mass spectrometry analysis, a microarray technology, a quantitative PCR methodology and combinations thereof.

17. A method according to claim 1, wherein said plurality of drugs appears in table 1 to table 4.

18. A method according to claim 1, wherein said pathway is selected from the group consisting of a Caspase Cascade pathway; a CREB pathway; a GPCR pathway; a CSK3 pathway; an HIF1Alpha pathway; an ILK pathway; an IP3 pathway; a PPAR pathway; a VEGF pathway; and combinations thereof.

19. A computer software product, said product configured for predicting a clinical outcome of a patient having breast cancer, the product comprising a computer-readable medium in which program instructions are stored, which instructions, when read by a computer, cause the computer to:
i. provide a drug score database (DSD) based on pathway activation strengths (PASs) for a plurality of biological pathways associated with the drug in the treatment of the breast cancer; and
ii. compare said pathway activation strengths of said plurality of biological pathways of said patient with said drug score database to provide a predictive indication if said patient is a responder or non-responder to said drug;
iii. repeat steps i) and ii) for a plurality of drugs thereby predicting a clinical outcome to said plurality of drugs of said patient to said breast cancer.

20. A computer software product, said product configured for defining a best treatment therapy for a patient having breast cancer, the product comprising a computer-readable medium in which program instructions are stored, which instructions, when read by a computer, cause the computer to:
i. provide a drug score database (DSD) based on pathway activation strengths (PASs) for a plurality of biological pathways associated with the therapy comprising at least one drug in the treatment of the breast cancer;
ii. compare said pathway activation strengths of said plurality of biological pathways of said patient with said drug score database to provide a predictive indication if said patient is a responder or non-responder to said drug;
iii. repeat steps i) and ii) for a plurality of drugs thereby predicting a clinical outcome to said plurality of drugs of said patient to said breast cancer; and
iv. output predictive results from step iii to provide a ranking table of best to worst therapies comprising at least one of said plurality of drugs, predicted for said patient for said cancer.
